(19) United States
(12) Patent Application Publication
(10) Pub. No.: US 2012/0327247 A1
(43) Pub. Date: Dec. 27, 2012

(54) AUTOMATED THERMAL SCOPE SET

(76) Inventors: Sergei Y. Mironichev, Moscow (RU); Pavel Alpatov, Moscow (RU)

(21) Appl. No.: 13/231,865

(22) Filed: Sep. 13, 2011

Related U.S. Application Data
(60) Provisional application No. 61/382,403, filed on Sep. 13, 2010.

(51) Int. Cl. F41G 1/00; H04N 5/33; G06F 19/00

(52) U.S. Cl. 348/164; 235/417; 235/404; 42/113; 348/E05.09

(57) ABSTRACT

An advanced weapon scope system, particularly for 21^{st} century nighttime tactical situations is disclosed herein. A preferred embodiment includes multiple sensors coupled to a thermal scope to provide input to a ballistics computer also provided to the scope. The device is further programmable and can record nighttime tactical events as desired by a user. Other features include automatic recognition of a living target based on a temperature threshold and automatic identification of weapon based on RFID scanning. Another preferred embodiment provides for command center remote monitoring via a wireless module such as Wi-Fi.

### PRIORITY CLAIM

This patent application contains subject matter claiming benefit of the priority date of U.S. Prov. Pat. App. Ser. No. 61/382,403 filed on Sep. 13, 2010, entitled AUTOMATED THERMAL SCOPE SET; accordingly, the entire contents of this provisional patent application is hereby expressly incorporated by reference.

### BACKGROUND OF THE INVENTION

1. Field of the Invention

The present invention relates generally to improvements in digital telescopic sights or scopes. More specifically, in a preferred embodiment, the present invention pertains to a thermal scope configured with flash memory, a ballistics computer, short range wireless transmission and remote control, as well as other novel features and methods provided herein.

2. Description of the Art

Techniques to enhance human night vision have been known for some time. One such technique enhances a human's ability to see outside of the visible light wavelength spectrum by employing a device to detect electromagnetic radiation having longer wavelengths (infrared) than visible light. Also known are thermal imaging cameras. Firefighters, for example, use thermal imaging cameras to locate hot spots and victims through smoke.

Weapon sights have additionally been introduced that are capable of viewing objects emitting infrared radiation. An early example was awarded patent protection in 1991 and proposed by Hansen, U.S. Pat. No. 5,035,472, entitled “Integrated Multispectral Man Portable Weapon Sight,” and was assigned to The United States of America, as represented by the Secretary of the Army. This particular invention was directed to an integrated electro-optical weapons' sight, and especially to a multispectral sight integrated with a weapon that may be used either in daytime, twilight, or nighttime environments without changing the sight. More recently, more powerful and cheaper electronics and the emergence of reliable wireless initiatives have opened up a myriad of possibilities in providing advanced features and capabilities to digital optics for weapon systems.

Accordingly, it is an object of the present invention to provide a thermal weapon sight configured with flash memory for video/audio recording useful as a real-time tactical sensor and for post event debriefing. It is an additional object of the present invention to provide a thermal weapon sight configured with Wi-Fi (wireless initiative IEEE 802.11) for remote engagement, or third party monitoring. It is yet further an object of the present invention to provide an eye sensor that is useful to save power during inactive periods. It is still further an object of the present invention to provide a programmable ballistics computer to a thermal scope coupled to useful indicators and sensors. Many other beneficial design characteristics are additionally provided by the present invention.

### BRIEF SUMMARY OF THE INVENTION

The present invention specifically addresses and alleviates the above mentioned deficiencies associated with the prior art. More particularly, the present invention, in a first aspect is a weapon scope system, the system comprising: a thermal imager for detecting radiation in an infrared spectrum; a central processing unit (CPU) coupled to the thermal imager providing automation thereto; a micro secure digital (SD) memory car for recording audio/video; and a wireless network module coupled to the CPU for sending and receiving data and user commands.

Further, the system herein in this aspect comprises an image display coupled to the CPU; and a microcontroller interfacing the CPU to a plurality of sensors, wherein the plurality of sensors comprises a light sensor, the light sensor automated to provide optimum brightness of the image display from the perspective of a user. Other sensor herein include: an eye fundus detector for automatically saving power during inactive periods; a thermostat for providing trajectory input to a ballistics computer; an accelerometer for sensing alignment of the thermal imager and providing ballistics computer input thereto; and an magnetometer for also sensing alignment of the thermal imager and providing ballistics computer input thereto. Still further weather data is provided as an input to the ballistics computer, more specifically including a wind speed, a relative humidity, and a barometric pressure. This data could optionally be provided by a local sensor coupled to a thermal imaging device herein or remotely to the device via a wireless modules coupled to a weather station. Also, an ammunition type is provided to the ballistics computer for trajectory calculations.

Other components to the weapon scope system include: an on-line storage medium; a flash memory device; a universal serial bus device (USB) for connecting the device to an external computer providing functionality thereto, via the external computer; a key pad for providing local functionality to the weapon scope system; and a radio receiver-transmitter for providing remote functionality to the system.

Yet further, the weapon scope system further has a battery compartment, the battery compartment having an endcap, the endcap being replaceable with a flashlight head lamp for added functionality.

In a second aspect, the invention may be characterized as a weapon scope system, the system comprising: a thermal imager for detecting radiation in an infrared spectrum; a central processing unit (CPU) coupled to the thermal imager providing automation thereto; a wireless network module coupled to the CPU for sending and receiving data and user commands; a first image display coupled to the CPU; and a second image display remote from the first image display, the second image display receiving data via the wireless network module. Additionally a third image display could be provided; the second image being a helmet mounted display (HMD) and the third being a command center computer monitor, for example.

Another feature of the present invention is a red dot sight for guidance on a target that is small in size, or close in range appearing suddenly, or in high magnification. Additionally as in the first aspect, a microcontroller is provided interfacing the CPU to a plurality of sensors, wherein the plurality of sensors comprises a light sensor, the light sensor automated to provide optimum brightness of the image display from the perspective of a user. A micro secure digital (SD) memory car for recording audio/video is also provided, further wherein the CPU is programmed to automatically retain audio/video data plus and minus 30 sec from a recoil event. As an additional feature of the present invention, when an amount of radiation reaches a threshold on a target reticle, a sign indicating “<<life>>” is flashed to a user.

The weapon system in this aspect is additionally characterized as further comprising: an individual weapon; and a ballistics computer for automatically calculation a target reticle position, wherein the individual weapon comprises a unique electronic identification, wherein the unique electronic identification is associated with a plurality of idiosyncratic gun parameters of the individual weapon, and wherein the idiosyncratic gun parameters are automatically entered to the ballistics computer.

Further to the ballistics computer herein, when the ballistics computer completes a solution, the display indicates a “ [symbol] ” and conversely when the ballistics computer ceases readiness, a blinking “ [symbol] ” indicates on the display.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a front perspective view of a thermal scope of the present invention;

FIG. 1B is a rear aspect perspective view of the preferred embodiment of the present invention that includes a red dot sight;

FIG. 2A is a an additional front aspect perspective view taken from an opposite side in relation to FIG. 1A;

FIG. 2B is a rear aspect perspective view thereof;

FIG. 2C is a top plan view thereof;

FIG. 2D is a side aspect view of the invention embodiment without the red dot sight;

FIG. 2E is a rear end view thereof;

FIG. 3 is a functional block diagram of the present invention illustrating internal and external components;

FIG. 4 is a perspective illustration of a thermal scope attached to a weapon; and

FIG. 5 is a schematical view of a system of the present invention illustrating remote command and control.

### DETAILED DESCRIPTION OF PREFERRED EMBODIMENTS

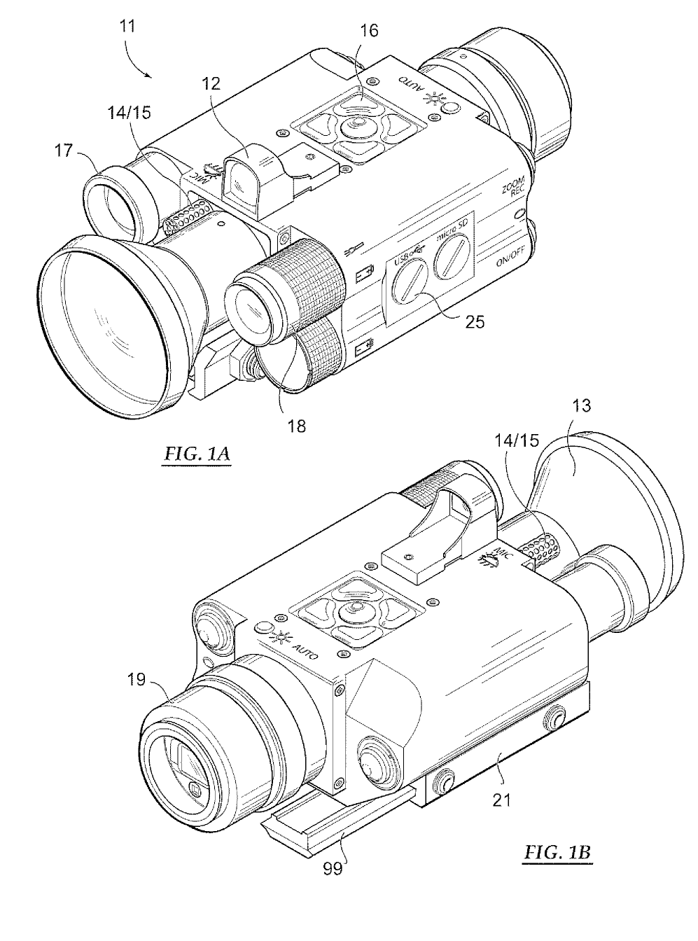

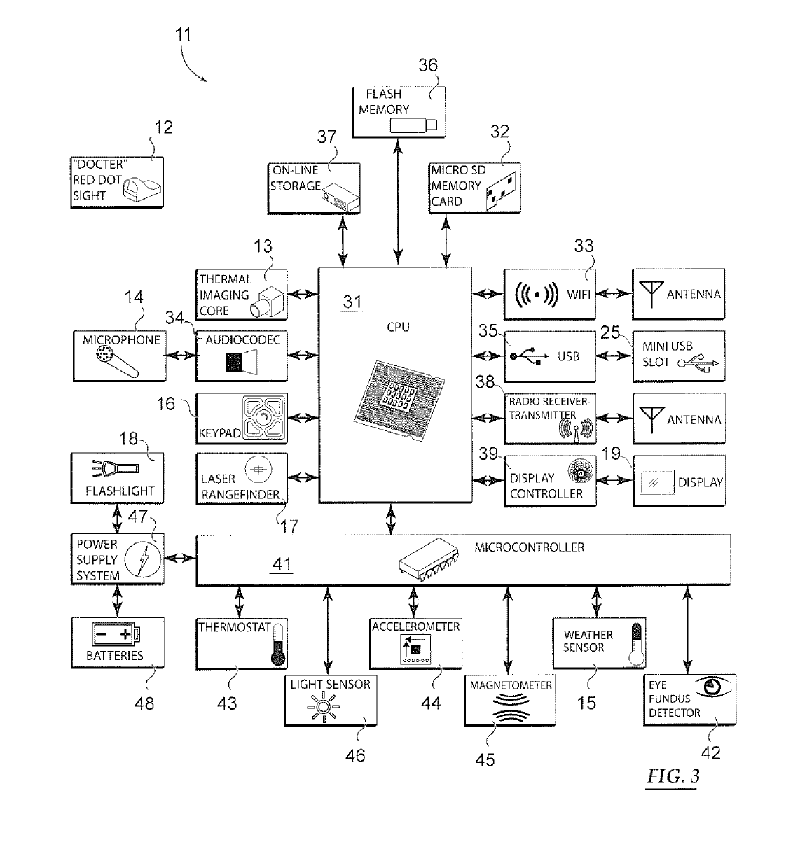

Initially with regard to FIG. 1A and FIG. 1B, alternative views of an automated thermal scope 11 set are illustrated. The scope 11 shown herein is one physical embodiment of a thermal core 13 as part of a weapons scope system 10 as described herein. In this configuration, the automated thermal scope 11 comprises digital zoom with automatic distortion compensation of target reticle 19 position. The scope 11 in this particular embodiment, further comprises a microphone 14, a Tau 320 thermal imager 13, a micro SD memory card 32 (FIG. 3) for recording audio/video, and a digital rangefinder 17. Further, the recording mode can be optionally automated recording +/−30 seconds from recoil; or other means for automation may be provided. In a preferred embodiment, the invention further comprises a radio transreceiver 33 (duplex) 434/686/2.4 Hz and configured for Wi-Fi, wireless transmission standard IEEE 802.11, for remote engagement and remote sensing. A second radio receiver-transmitter 38 is additional provided as detailed herein (FIG. 3). Particularly with reference to FIG. 1B, the scope 11 is also configured with a Weaver rail mount 21 design particularly suited to military applications via Weaver rail 99.

The FIG. 1A and FIG. 1B embodiment further includes a red dot type sight that is useful for fast acquisition of suddenly appearing targets or when the scope 13 is in high magnification. Additionally, the preferred embodiment 11 includes a two-button plus joystick keypad 16 for fine adjustments through menu systems. Optionally, the device can be controlled 38 remotely (FIG. 5). Since the device 11 is also a computer 31, a plurality of individual user profiles for forming and redirecting operation of control buttons is provided by the present invention (for e.g., on/off, brightness, zoom, or confirmation of initial data for ballistic calculation). Also as shown in this embodiment and explained herein, the microphone 14 is integrated to a weather sensor 15 in a forward portion of the scope 11.

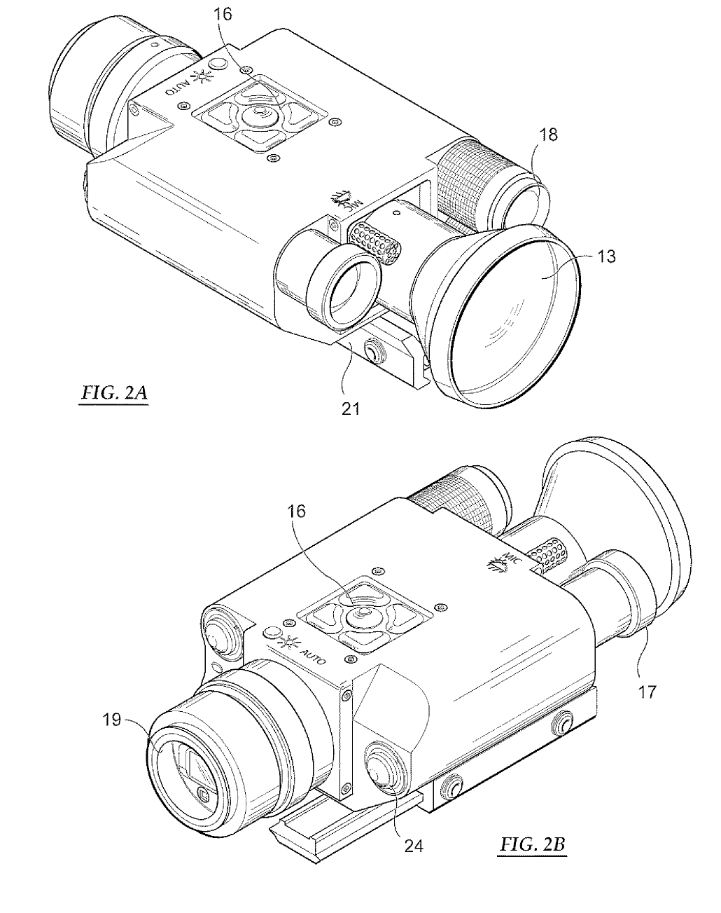

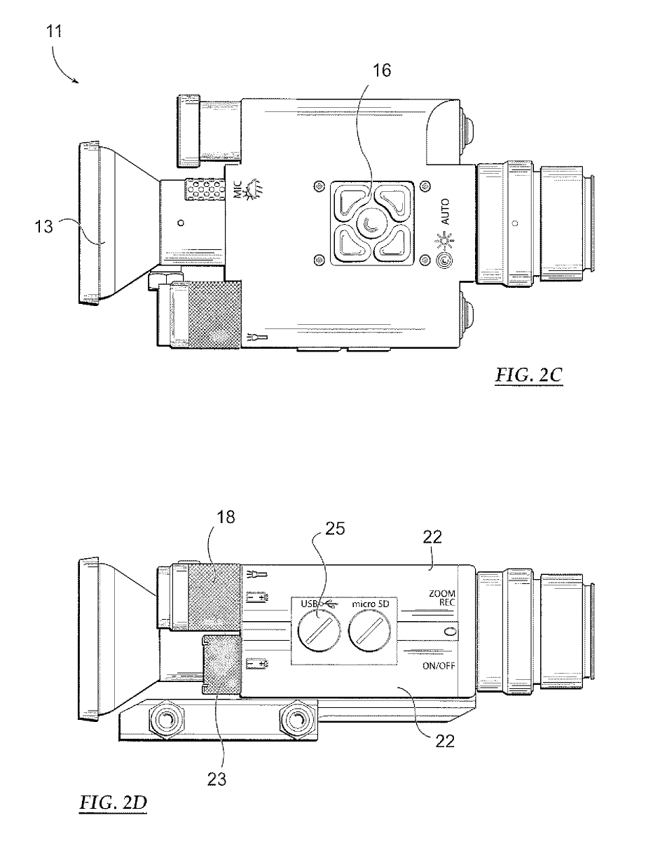

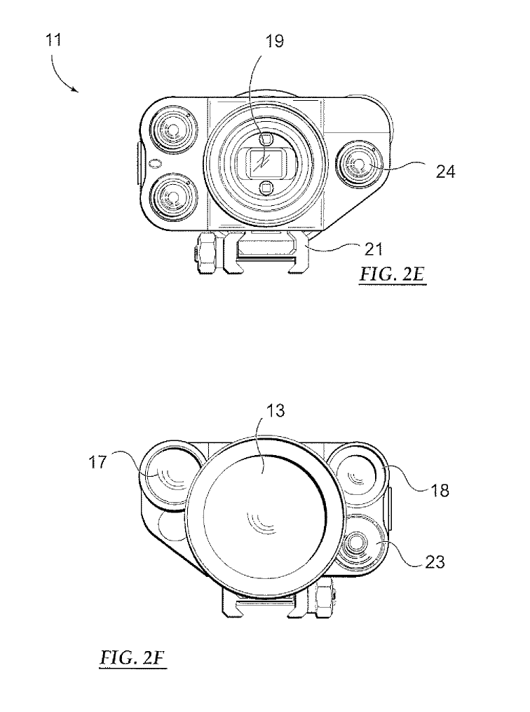

With regard to FIG. 2A through FIG. 2F, various alternative views of the thermal scope are provided. As shown in FIG. 2B, a battery compartment 22 is provided to house rechargeable batteries 48. Battery compartment endcaps 23 are provided for access to compartments 22. However in a preferred embodiment, an endcap 23 may be replace by a flashlight head lamp 18 for added functionality to the scope 11. Additional control buttons 24 are provided by the present invention for ease of operation such as manual ON/OFF and digital zoom.

FIG. 3 illustrates a functional block diagram of internal and external components in various embodiments of the present thermal scope 11. It should be well appreciated that the same concepts herein could be applied to a daytime scope set and recording device that senses light in the visible spectrum, such as a charge-coupled device. As stated, central processing unit (CPU) 31 provides computing and programmability to the present invention 10, additionally serving as a ballistics computer for calculating projectile trajectory in any condition based on a multitude of parameters 15, 43, 44, 45 as described herein. Specifically, the ballistics computer 31 is coupled to input data sensors 15, 43, 44, 45 and, if needed or desired, further coupled to a USB connection 25, for wired data transfer to/from an external computer 51. The input data sensors include ambient temperature 43, atmospheric pressure 15, a position angle sensor 45 and tilt angle sensor 44 relative to a stable platform. Also included are internal 17 and external digital rangefinders, as well as other sensors such as humidity 15. Optionally, the weather station 15 could be a component physically coupled to the scope 11 as shown, or received by radio transmission 33 from a remote weather station. Further, an ammunition type is provided as an input to the ballistics computer 31. Microcontroller 41 is provided as an interface between CPU 31 and sensors 15, 43, 44, 45.

Further to FIG. 3, a local display 19 is coupled to the CPU via a display controller controllable by keypad 16 and additional control buttons 24 (FIG. 1A through FIG. 2G). Memory devices include micro SD memory card 32, flash memory 36, and on-line volatile storage 37. Power supply system is provided to either power the device 11 via its batteries 48 or though a USB device 25, 35 to an external computer or an external power supply.

The embodiment 11 shown further has wireless capability other than via Wi-Fi module 33. A hand held remote can be provided to a field operator 55 to control the scope 11 through radio receiver-transmitter 38 (e.g. FIG. 5). An ambient light sensor 46 is also provided for automated set-up for optimum screen brightness further for convenience and for the purpose of reducing eye fatigue.

As stated herein, the device 11 is programmable by a manufacturer or a user. In one example, the device 11 is able to identify a live target (versus a deceased target) based on a threshold temperature. In this event, <<life>> is flashed to the display 19. Further, the invention contemplates the ability to automatically identify a particular weapon through remote control 38 or an RFID device integrated into a gunstock. Also as stated, according to a preferred embodiments, a red dot sight 12 may be coupled to the thermal scope of the present invention. An alternative method of configuring a red dot sight 12 is to integrate it to a battery compartment end cap 23. The red dot feature 12 will be particularly useful for suddenly appearing, short range targets. Additionally, the red dot sight 12 feature is useful for guidance on target while in high magnification.

Further to range finder 17 and ballistic computer 31 embodiments of the present invention, a connectable module 17 comprising a laser rangefinder with automatic input to the ballistics computer 31 is provided herein. The input to the ballistics computer 31 provides for automatic calculation of target reticle position 19 further based on weather data 15, 43 and ammunition type. Also in the preferred embodiment, shooting readiness is indicated with a << [symbol] >>, and cease readiness is indicated with <<smiley blinking>>.

Additionally, the preferred embodiment includes a security feature, disabling the device 11, and preventing the scope 11 from being used for illegal purposes by criminals or enemy combatants. The security feature could be activated remotely according to the invention.

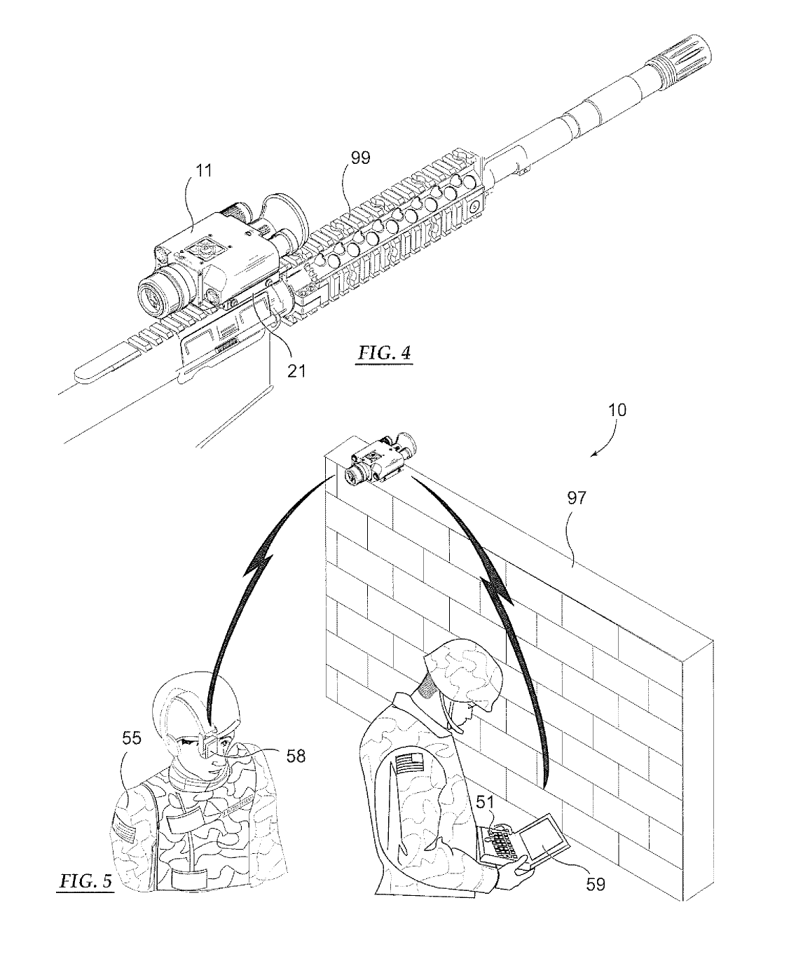

With reference to FIG. 4, a device 11 is coupled to a rifle via a weaver rail 99 and a weaver mount 21. FIG. 5 illustrates an exemplary weapon scope system 10 of the present invention illustrating remote displays 58, 59 of the present invention, particularly useful for third party, or control center monitoring. A Head Up Display (HUD), or a helmet mounted display (HMD) 58 could be employed for remote use (behind corner or wall 97, for example). A first way to implement the remote display is with a projection on a semitransparent mirror 58 in front of an eye. A second way would be to implement the display to a visor that could be pulled down from the helmet.

While the particular Automated Thermal Scope Set as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims (to be added upon conversion). Appendix A provides additional disclosure and is enclosed herewith.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Automated Thermal Scope Set as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A weapon scope system, the system comprising:
a thermal imager for detecting radiation in an infrared spectrum;
a central processing unit (CPU) coupled to the thermal imager providing automation thereto;
a micro secure digital (SD) memory car for recording audio/video; and
a wireless network module coupled to the CPU for sending and receiving data and user commands.

2. The weapon scope system of claim 1 further comprising:
an image display coupled to the CPU; and
a microcontroller interfacing the CPU to a plurality of sensors, wherein the plurality of sensors comprises a light sensor, the light sensor automated to provide optimum brightness of the image display from the perspective of a user.

3. The weapon scope system of claim 2, the plurality of sensors further comprising:
an eye fundus detector for automatically saving power during inactive periods;
a thermostat for providing trajectory input to a ballistics computer;
an accelerometer for sensing alignment of the thermal imager and providing ballistics computer input thereto; and
an magnetometer for sensing alignment of the thermal imager and providing ballistics computer input thereto.

4. The weapon scope system of claim 3 further comprising weather data input to the ballistics computer.

5. The weapon scope system of claim 4 further wherein the weather data comprises a wind speed, a relative humidity, and a barometric pressure, and further wherein the weapon scope system further comprises an ammunition type as input to the ballistics computer.

6. The weapon scope system of claim 4 further wherein the weather data originates from a remote weather station.

7. The weapon scope system of claim 1, further comprising:
an on-line storage medium;
a flash memory device;
a universal serial bus device (USB) for connecting the device to an external computer providing functionality thereto, via the external computer;
a key pad for providing local functionality to the weapon scope system; and
a radio receiver-transmitter for providing remote functionality to the system.

8. The weapon scope system of claim 1, further comprising a battery compartment, the battery compartment having an endcap, the endcap being replaceable with a flashlight head lamp.

9. A weapon scope system, the system comprising:
a thermal imager for detecting radiation in an infrared spectrum;
a central processing unit (CPU) coupled to the thermal imager providing automation thereto;
a wireless network module coupled to the CPU for sending and receiving data and user commands;
a first image display coupled to the CPU; and
a second image display remote from the first image display, the second image display receiving data via the wireless network module.

10. The weapon scope system of claim 9 further comprising red dot sight for guidance on a target that is small in size, or close in range, or in high magnification.

11. The weapon scope system of claim 9 further comprising:
a microcontroller interfacing the CPU to a plurality of sensors, wherein the plurality of sensors comprises a light sensor, the light sensor automated to provide optimum brightness of the image display from the perspective of a user; and
a micro secure digital (SD) memory car for recording audio/video, further wherein the CPU is programmed to automatically retain audio/video data plus and minus 30 sec from a recoil event.

12. The weapon scope system of claim 9 wherein when an amount of radiation reaches a threshold on a target reticle, a sign indicating “<<life>>” is flashed.

13. The weapon scope system of claim 9 further comprising:
an individual weapon; and
a ballistics computer for automatically calculation a target reticle position, wherein the individual weapon comprises a unique electronic identification, wherein the unique electronic identification is associated with a plurality of idiosyncratic gun parameters of the individual weapon, and wherein the idiosyncratic gun parameters are automatically entered to the ballistics computer.

14. The weapon scope system of claim 13 wherein When the ballistics computer completes a solution, a display indicates a “ [symbol] ” and wherein when the ballistics computer ceases readiness a blinking “ [symbol] ” indicates on the display.
